(19) United States
(12) Patent Application Publication
(10) Pub. No.: US 2024/0369279 A1
(43) Pub. Date: Nov. 7, 2024

(54) Beverage Cooler Assembly

(71) Applicant: William Kessel, Colville, WA (US)

(72) Inventor: William Kessel, Colville, WA (US)

(21) Appl. No.: 18/142,638

(22) Filed: May 3, 2023

(51) Int. Cl. F25D 3/08; B67D 3/00; B67D 3/02

(52) U.S. Cl. CPC F25D 3/08; B67D 3/0067; B67D 3/02; F25D 2331/806

(57) ABSTRACT

A beverage cooler assembly for facilitating a beverage to be completely emptied from a beverage cooler includes a beverage cooler that has a sloped floor to direct a beverage in the beverage cooler to run downwardly along the sloped floor. A spigot is aligned with a low point of the sloped floor of the beverage cooler to receive the beverage in the beverage cooler. A lid is removably positionable on the beverage cooler for closing the beverage cooler.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooler devices and more particularly pertains to a new cooler device for facilitating a beverage to be completely emptied from a beverage cooler. The device includes a beverage cooler that has a sloped floor and a spigot aligned with a low point of the sloped floor. In this way the sloped floor facilitates the beverage in the beverage cooler to be completely emptied through the spigot.

### (2) Description of Related Art Including Information Disclosed Under 37 CFR 1.97 and 1.98

The prior art relates to cooler devices including a variety of beverage coolers that each has some manner of sloped floor and a spigot aligned with a low point of the sloped floor; the sloped floor is defined by a variety of means that are secondary to the structure of the beverage cooler and in at least one instance includes structural features to direct the flow of fluid along the sloped floor. In no instance does the prior art discloses a beverage cooler that has a sloped floor which is a unitary structure of the beverage container.

### BRIEF SUMMARY OF THE INVENTION

An embodiment of the disclosure meets the needs presented above by generally comprising a beverage cooler that has a sloped floor to direct a beverage in the beverage cooler to run downwardly along the sloped floor. A spigot is aligned with a low point of the sloped floor of the beverage cooler to receive the beverage in the beverage cooler. A lid is removably positionable on the beverage cooler for closing the beverage cooler.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a beverage cooler assembly according to an embodiment of the disclosure.

FIG. 2 is a top exploded view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

FIG. 6 is a magnified detail view taken from circle 6 of FIG. 5 of an embodiment of the disclosure.

### DETAILED DESCRIPTION OF THE INVENTION

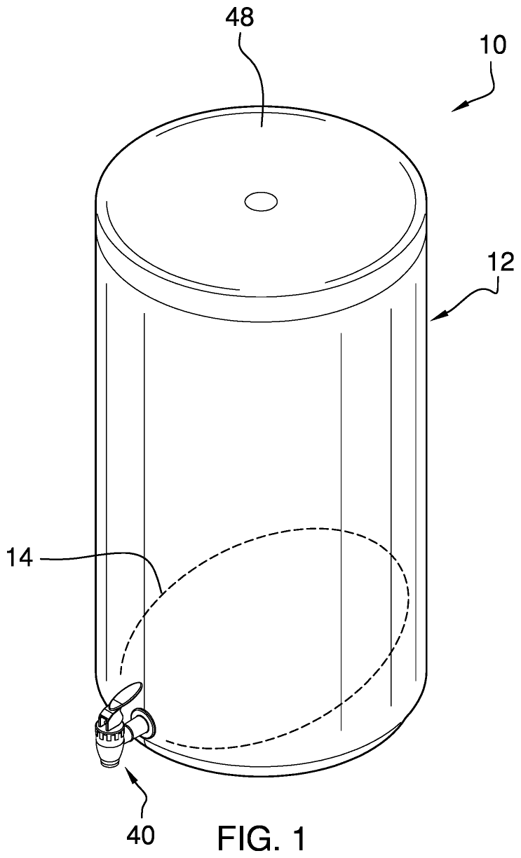

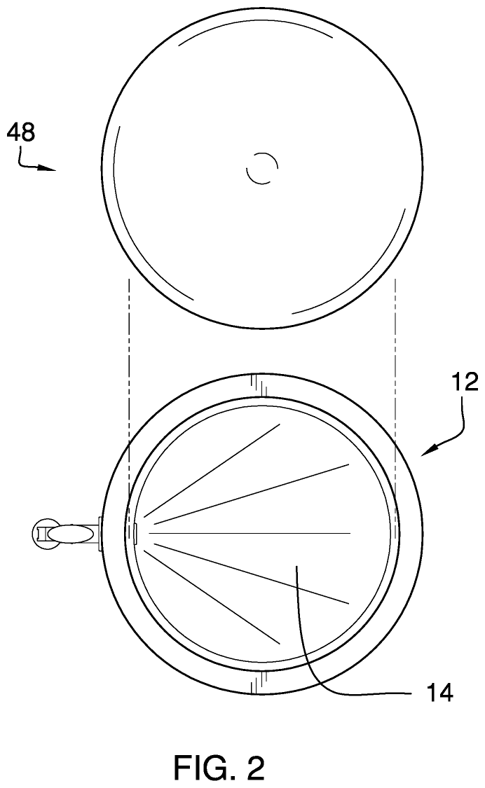

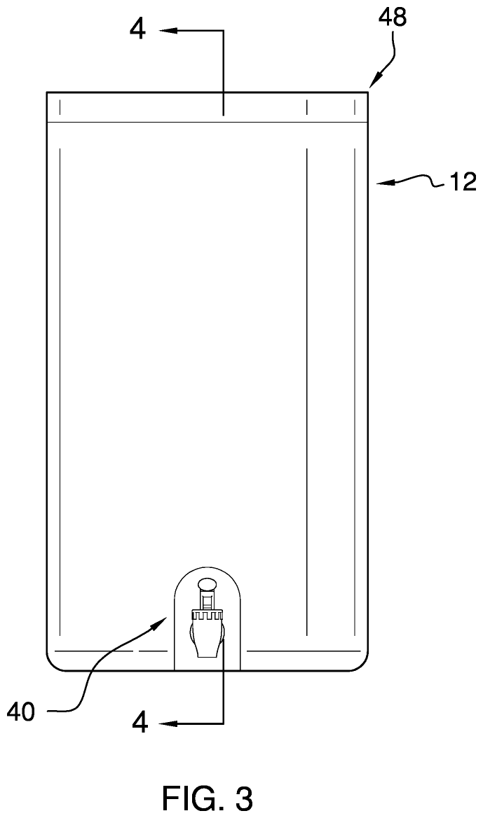

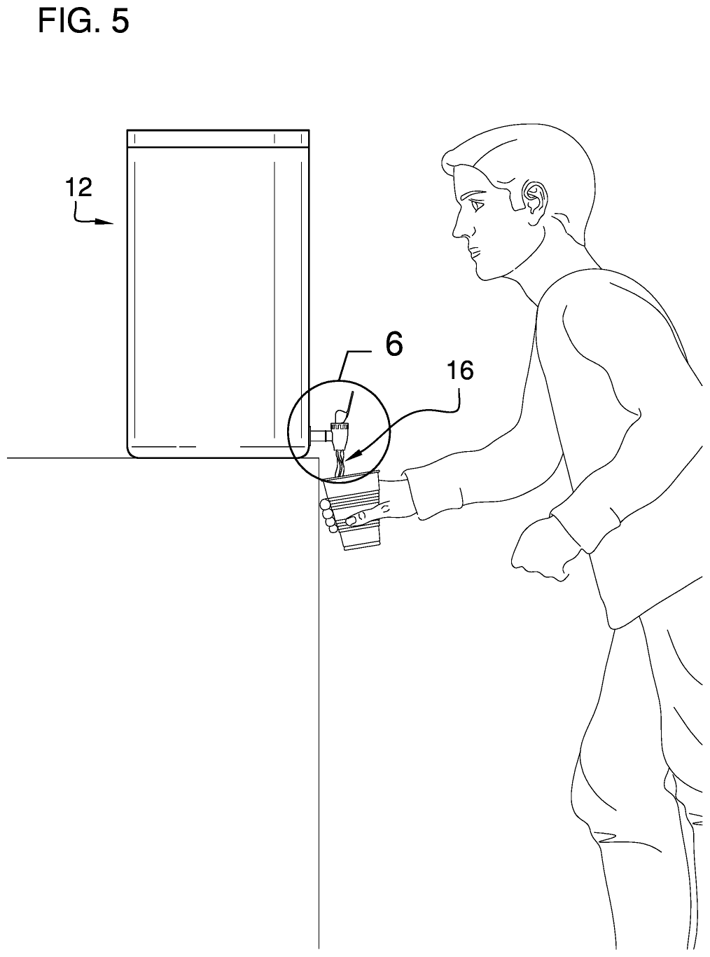

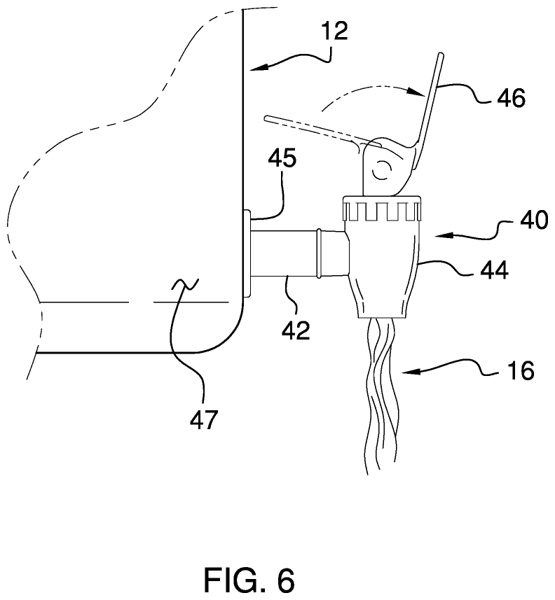

With reference now to the drawings, and in particular to FIGS. 1 through 6 thereof, a new cooler device embodying the principles and concepts of an embodiment of the disclosure and generally designated by the reference numeral 10 will be described.

As best illustrated in FIGS. 1 through 6, the beverage cooler assembly 10 generally comprises a beverage cooler 12 that has a sloped floor 14 to direct a beverage 16 in the beverage cooler 12 to run downwardly along the sloped floor 14. The beverage cooler 12 has a bottom wall 18 and a perimeter wall 20 extending upwardly from the bottom wall 18 and the perimeter wall 20 is continuously arcuate about a center point of the bottom wall 18 such that the beverage cooler 12 has a cylindrical shape. The perimeter wall 20 has an upper edge 22 defining an opening 24 into an interior of the beverage cooler 12. Additionally, the beverage cooler 12 is comprised of a thermally insulating material to inhibit thermal communication between the beverage 16 and ambient air.

The bottom wall 18 has an upper surface 26 and a lower surface 28 and the upper surface 26 lies on a plane that is angled toward the lower surface 28 such that the upper surface 26 defines the sloped floor 14 of the beverage cooler 12. The upper edge 22 has a groove 30 extending around a full circumference of the perimeter wall 20. The groove 30 is aligned with an inside surface 32 of the perimeter wall 20 and the groove 30 has a lower bounding surface 34. The beverage cooler 12 has a hole 36 extending through the perimeter wall 20. The hole 36 is positioned adjacent to a low point 38 of the upper surface 26 of the bottom wall 18 thereby facilitating the hole 36 to receive the beverage 16 in the beverage cooler 12.

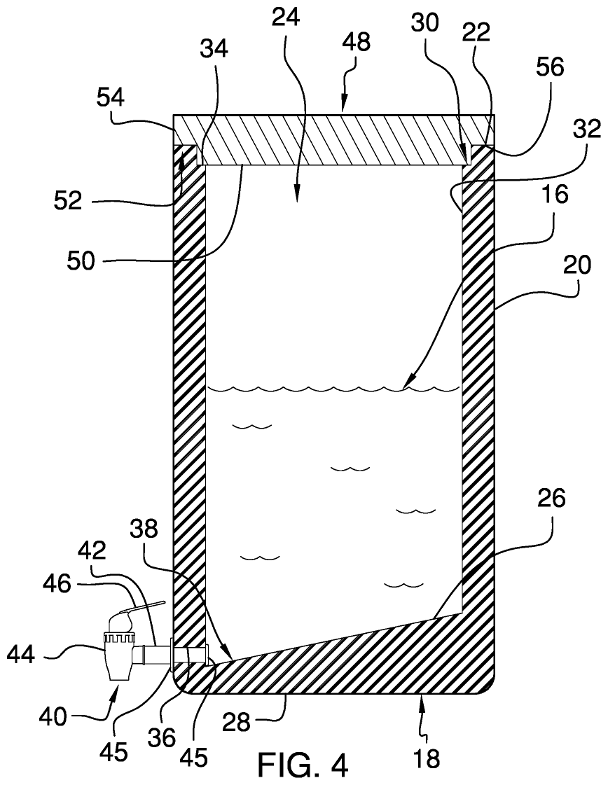

A spigot 40 is attached to the beverage cooler 12 and the spigot 40 is aligned with a low point of the sloped floor 14 of the beverage cooler 12 such that the spigot 40 receives the beverage 16 in the beverage cooler 12. The spigot 40 has a stem 42 and a spout 44 that is perpendicularly oriented with the stem 42. The spout 44 includes a lever 46 for urging the spout 44 between an open condition and a closed condition. The stem 42 extends through the hole 36 in the perimeter wall 20 of the beverage cooler 12 having the spout 44 is positioned outside of the beverage cooler 12 to direct the beverage 16 into the spout 44. The spout 44 dispenses the beverage 16 when the lever 46 is manipulated to urge the spout 44 into the open condition to facilitate the beverage 16 to be consumed. Conversely, the spout 44 retains the beverage 16 in the beverage cooler 12 when the lever 46 is manipulated to urge the spout 44 into the closed condition. As is shown in FIG. 4, the stem includes a pair of washers 45 that each abut a respective one of the inside surface 32 and an outside surface 47 of the perimeter wall of the beverage cooler 12.

A lid 48 is removably positionable on the beverage cooler 12 for closing the beverage cooler 12. The lid 48 has a bottom surface 50 and the lid 48 has a channel 52 extending into the bottom surface 50. The channel 52 extends around a full circumference of the lid 48 and the channel 52 is aligned with an outside surface 54 of the lid 48. The channel 52 has an upper bounding surface 56 and the upper bounding surface 56 lies on the upper edge 22 of the perimeter wall 20 of the beverage cooler 12 having the bottom surface 50 of the lid 48 lying on the lower bounding surface 34 of the groove 30 in the perimeter wall 20 of the beverage cooler 12 when the lid 48 closes the beverage cooler 12. In this way the lid 48 forms a seal to inhibit thermal communication between the beverage 16 and ambient air when the lid 48 is positioned on the beverage cooler 12. Additionally, the lid 48 is comprised of a thermally insulating material for further inhibit thermal communication between the beverage 16 and ambient air.

In use, the beverage 16 is poured into the beverage cooler 12 and the lid 48 is placed on the beverage cooler 12 for storing the beverage 16. The lever 46 on the spigot 40 is manipulated to urge the spout 44 into the open condition for dispensing the beverage 16. Furthermore, the sloped floor 14 of the beverage cooler 12 ensures that all of the beverage 16 can be dispensed from the beverage cooler 12 without having to tip the beverage cooler 12 as is commonly required with existing beverage coolers. In this way the beverage 16 can be completely dispensed from the beverage cooler 12 without the risk of the beverage cooler 12 falling over and spilling the beverage 16.

With respect to the above description then, it is to be realized that the optimum dimensional relationships for the parts of an embodiment enabled obey the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage cooler assembly having a sloped floor for directing a beverage to a dispensing spigot, said assembly comprising:
a beverage cooler having a sloped floor wherein said sloped floor is configured to direct a beverage in said beverage cooler to run downwardly along said sloped floor;
a spigot being attached to said beverage cooler, said spigot being aligned with a low point of said sloped floor of said beverage cooler wherein said spigot is configured to receive the beverage in said beverage cooler; and
a lid being removably positionable on said beverage cooler for closing said beverage cooler.

2. The assembly according to claim 1, wherein:
said beverage cooler has a bottom wall and a perimeter wall extending upwardly from said bottom wall, said perimeter wall being continuously arcuate about a center point of said bottom wall such that said beverage cooler has a cylindrical shape, said perimeter wall having an upper edge defining an opening into an interior of said beverage cooler, said bottom wall having an upper surface and a lower surface, said upper surface lying on a plane being angled toward said lower surface such that said upper surface defines said sloped floor of said beverage cooler; and
said upper edge has a groove extending around a full circumference of said perimeter wall, said groove being aligned with an inside surface of said perimeter wall, said groove having a lower bounding surface.

3. The assembly according to claim 2, wherein said beverage cooler has a hole extending through said perimeter wall, said hole being positioned adjacent to a low point of said upper surface of said bottom wall wherein said hole is configured to receive the beverage in said beverage cooler.

4. The assembly according to claim 1, wherein said beverage cooler is comprised of a thermally insulating material wherein said beverage cooler is configured to inhibit thermal communication between the beverage and ambient air.

5. The assembly according to claim 3, wherein said spigot has a stem and a spout being perpendicularly oriented with said stem, said spout including a lever for urging said spout between an open condition and a closed condition, said stem extending through said hole in said perimeter wall of said beverage cooler having said spout being positioned outside of said beverage cooler wherein said stem is configured to direct the beverage into said spout, said spout dispensing the beverage when said lever is manipulated to urge said spout into said open condition wherein said spout is configured to facilitate the beverage to be consumed, said spout retaining the beverage in said beverage cooler when said lever is manipulated to urge said spout into said closed condition.

6. The assembly according to claim 2, wherein said lid has a bottom surface, said lid having a channel extending into said bottom surface, said channel extending around a full circumference of said lid, said channel being aligned with an outside surface of said lid, said channel having an upper bounding surface, said upper bounding surface lying on said upper edge of said perimeter wall of said beverage cooler having said bottom surface of said lid lying on said lower bounding surface of said groove in said perimeter wall of said beverage cooler wherein said lid is configured to inhibit thermal communication between the beverage and ambient air when said lid is positioned on said beverage cooler.

7. A beverage cooler assembly having a sloped floor for directing a beverage to a dispensing spigot, said assembly comprising:
a beverage cooler having a sloped floor wherein said sloped floor is configured to direct a beverage in said beverage cooler to run downwardly along said sloped floor, said beverage cooler having a bottom wall and a perimeter wall extending upwardly from said bottom wall, said perimeter wall being continuously arcuate about a center point of said bottom wall such that said beverage cooler has a cylindrical shape, said perimeter wall having an upper edge defining an opening into an interior of said beverage cooler, said bottom wall having an upper surface and a lower surface, said upper surface lying on a plane being angled toward said lower surface such that said upper surface defines said sloped floor of said beverage cooler, said upper edge having a groove extending around a full circumference of said perimeter wall, said groove being aligned with an inside surface of said perimeter wall, said groove having a lower bounding surface, said beverage cooler having a hole extending through said perimeter wall, said hole being positioned adjacent to a low point of said upper surface of said bottom wall wherein said hole is configured to receive the beverage in said beverage cooler, said beverage cooler being comprised of a thermally insulating material wherein said beverage cooler is configured to inhibit thermal communication between the beverage and ambient air;
a spigot being attached to said beverage cooler, said spigot being aligned with a low point of said sloped floor of said beverage cooler wherein said spigot is configured to receive the beverage in said beverage cooler, said spigot having a stem and a spout being perpendicularly oriented with said stem, said spout including a lever for urging said spout between an open condition and a closed condition, said stem extending through said hole in said perimeter wall of said beverage cooler having said spout being positioned outside of said beverage cooler wherein said stem is configured to direct the beverage into said spout, said spout dispensing the beverage when said lever is manipulated to urge said spout into said open condition wherein said spout is configured to facilitate the beverage to be consumed, said spout retaining the beverage in said beverage cooler when said lever is manipulated to urge said spout into said closed condition; and
a lid being removably positionable on said beverage cooler for closing said beverage cooler, said lid having a bottom surface, said lid having a channel extending into said bottom surface, said channel extending around a full circumference of said lid, said channel being aligned with an outside surface of said lid, said channel having an upper bounding surface, said upper bounding surface lying on said upper edge of said perimeter wall of said beverage cooler having said bottom surface of said lid lying on said lower bounding surface of said groove in said perimeter wall of said beverage cooler wherein said lid is configured to inhibit thermal communication between the beverage and ambient air when said lid is positioned on said beverage cooler.
